(19) United States
(12) Patent Application Publication
(10) Pub. No.: US 2012/0221708 A1
(43) Pub. Date: Aug. 30, 2012

(54) Distributed content popularity tracking for use in memory eviction

(75) Inventors: Manish Bhardwaj, San Jose, CA (US); Ping Chieh Chen, San Jose, CA (US)

(73) Assignee: CISCO TECHNOLOGY, INC., San Jose, CA (US)

(21) Appl. No.: 12/932,429

(22) Filed: Feb. 25, 2011

(51) Int. Cl. G06F 15/173

(52) U.S. Cl. 709/224

(57) ABSTRACT

In one embodiment, a method includes storing at a node in a distributed network of nodes, an object associated with an object descriptor comprising popularity information for the object, each of the nodes storing a plurality of the objects and object descriptors, the node in communication with a server storing objects that are less popular than the objects stored at the nodes, and transmitting from the node to the server, one of the objects identified as less popular than one of the objects stored at the server. One of the nodes receives and stores the object from the server. An apparatus is also disclosed.

### TECHNICAL FIELD

The present disclosure relates generally to content popularity tracking, and more particularly, content popularity tracking for use in memory eviction.

### BACKGROUND

Content eviction algorithms are used to provide effective cache utilization. Various replacement policies may be used to decide which objects remain in cache and which are evicted to make space for new objects. When the number of cached objects grows extremely large, conventional centralized systems do not provide adequate support.

An example of a distributed system is a distributed hash table (DHT). DHTs are a class of decentralized distributed systems that provide a lookup service similar to a hash table. Name and value pairs are stored in the DHT and any participating node can efficiently retrieve the value associated with a given name. Responsibility for maintaining the mapping from names to values is distributed among the nodes, in such a way that a change in the set of participants causes a minimal amount of disruption. This allows DHTs to scale to large numbers of nodes and to handle continual node arrivals, departures, and failures.

### BRIEF DESCRIPTION OF THE FIGURES

FIG. 1 illustrates an example of a network in which embodiments described herein may be implemented.

FIG. 2 illustrates an example of a network device useful in implementing embodiments described herein.

FIG. 3 is a flowchart illustrating an overview of a process for content popularity tracking and eviction in a distributed system, in accordance with one embodiment.

FIG. 4 is an example of hash and descriptor data structures at storage nodes in the network of FIG. 1.

FIG. 5 is an example of a global descriptor data structure for use in tracking popularity of objects in the network of FIG. 1.

Corresponding reference characters indicate corresponding parts throughout the several views of the drawings.

### DESCRIPTION OF EXAMPLE EMBODIMENTS

### Overview

In one embodiment, a method generally comprises storing at a node in a distributed network of nodes, an object associated with an object descriptor comprising popularity information for the object, each of the nodes storing a plurality of the objects and object descriptors, the node in communication with a server storing objects that are less popular than the objects stored at the nodes, and transmitting from the node to the server, one of the objects identified as less popular than one of the objects stored at the server. One of the nodes receives and stores the object from the server.

In another embodiment, an apparatus generally comprises memory for storing at a node configured for operation in a distributed network of nodes, objects associated with object descriptors each comprising popularity information for the object, each of the nodes comprising a plurality of objects and object descriptors, the node configured for communication with a server storing objects that are less popular than the objects stored at the nodes. The apparatus further includes a processor for transmitting from the apparatus to the server, one of the objects identified as less popular than one of the objects at the server. One of the nodes receives and stores the object from the server.

### Example Embodiments

The following description is presented to enable one of ordinary skill in the art to make and use the embodiments. Descriptions of specific embodiments and applications are provided only as examples and various modifications will be readily apparent to those skilled in the art. The general principles described herein may be applied to other embodiments and applications. Thus, the embodiments are not to be limited to those shown, but are to be accorded the widest scope consistent with the principles and features described herein. For purpose of clarity, features relating to technical material that is known in the technical fields related to the embodiments have not been described in detail.

The embodiments described herein provide a distributed content popularity tracking scheme for use in content eviction decisions. Since the scheme is distributed, it can track popularity of a very large number of objects. The embodiments operate to evict content in a globally fair manner (i.e., evict the globally least popular content from the distributed system). As described in detail below, objects (e.g., content including, for example, data, video, audio, or any combination thereof) are stored in a distributed system comprising nodes for storing popular objects, and a server for storing less popular objects. The embodiments may be used, for example, by a content distributor to store popular content on edge servers or other nodes in an overlay network and evict less popular content. The embodiments may also be used by content providers to extract popularity analytics about their content, for example.

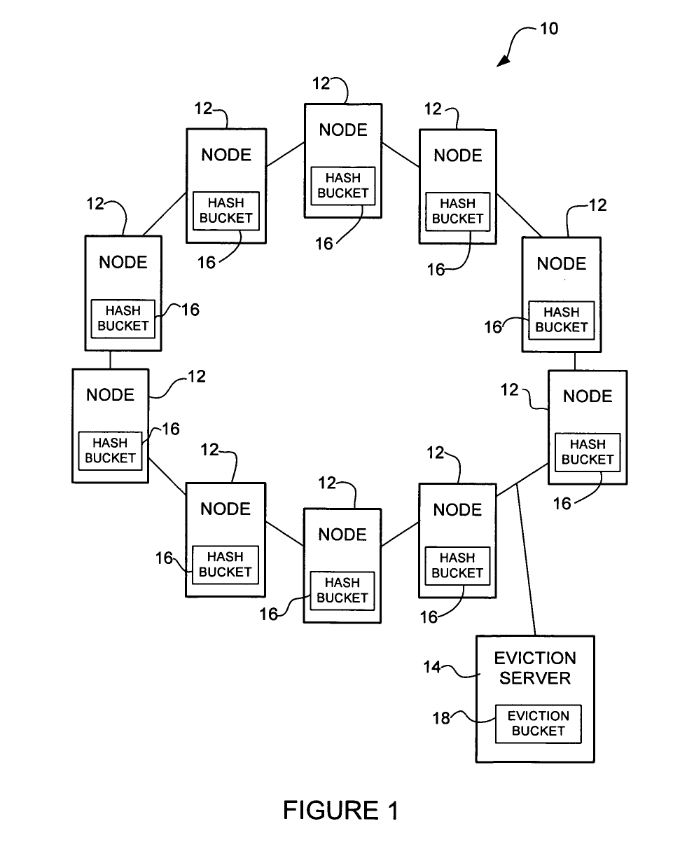

The embodiments operate in the context of a data communication network including multiple network elements. Referring now to the figures, and first to FIG. 1, an example of a network that may implement embodiments described herein is shown. The network includes a plurality of storage nodes 12 that form an overlay network. The node 12 may be, for example, a server or other network device comprising a content delivery engine (e.g., Content Delivery System—Internet Streamer), or any other network device configured to store and deliver content. The nodes 12 may be located, for example, in an enterprise or peer-to-peer network and configured to store any number of objects (e.g., million objects, or more or less than a million objects). The nodes 12 may be part of a content delivery system, which may provide, for example, streaming applications for content delivery to digital televisions and set-top boxes or Internet streaming applications for content delivery to IP devices such as personal computers, mobile phones, and handheld devices. The nodes 12 may also be used for web caching, for example. Content may be received from content sources such as a component within a television services network, content delivery network, Internet, or any other source. The nodes 12 may be in communication with the content source directly or via any number of network devices (e.g., content acquirer, content vault, router, switch, etc.). The nodes 12 may also be in communication with one or more user devices (e.g., television, personal computer, mobile phone, handheld device, etc.) or other content receiver. Any number of network devices may also be interposed between the nodes 12 and the user devices.

The nodes 12 are in communication with a server (referred to herein as an eviction server) 14. The eviction server 14 comprises one or more storage network devices (e.g., backend server). The eviction server 14 may also comprise a network of nodes (e.g., storage nodes 12) or any other type or arrangement of network devices configured to store and deliver content. As described in detail below, less popular objects, which typically comprise a large majority of the content, are stored in the eviction server 14, while more popular objects, which are typically few in number, are stored in the nodes 12. The eviction server 14 thus stores content that is less popular, and less frequently accessed, than content stored at the nodes 12. Although the content stored at the eviction server 14 is not requested as often as the more popular content, it is still available for delivery (e.g., streaming, file transfer, etc.) to users or other network devices whenever requested.

Popularity refers to the relative access frequencies of requested objects. Any policy may be used to determine popularity of an object, including, for example, GDS (Greedy Dual Size), LFU (Least Frequently Used), etc. Popularity information may be updated when an object is accessed or at periodic intervals.

In one embodiment, the nodes 12 form an overlay distributed hash table (DHT) network. The nodes 12 comprise distributed hash table storage nodes that form a ring to cache descriptors of objects. The distributed hash table is a data structure that is distributed in the nodes 12 in the network. Each node 12 belonging to the DHT is responsible for a range of a complete space of keys. Each key can have one or more values assigned thereto. Each storage node 12 may be a DHT per se or may be another DHT-like entity that supports a distributed interface of a DHT even though it may be implemented in another way internally.

The DHT ring operates as an autonomous content indexing and delivery system via basic PUT/GET operations. Data is stored in the DHT by performing a PUT (key, value) operation. The value is stored at a location, typically in one DHT storage node 12, that is indicated by the key field of the PUT message. Data is retrieved using a GET (key) operation, which returns the value stored at the location indicated by the key field in the GET message. Content is indexed by hashing an extensible resource identifier (xri) of the content to generate a key. The value of the key is a descriptor that contains meta-data about the object, such as locations where the content is stored (resources) and popularity of the object. The content can be located by hashing the xri and performing a GET on the generated key to retrieve the descriptor. The content can then be downloaded from the resources listed in the descriptor. It is to be understood that the distributed hash table described herein is just one example of a distributed data structure and that other types of distributed systems may be used without departing from the scope of the embodiments.

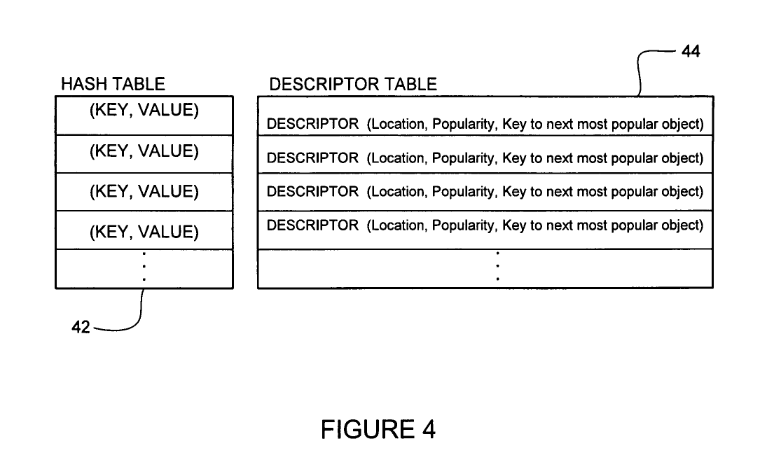

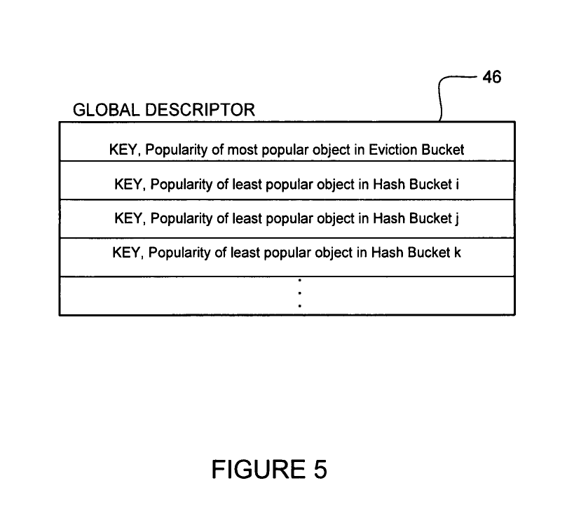

In one embodiment, each node 12 includes a hash bucket 16 and the eviction server 14 includes one or more eviction buckets 18. As described in detail below with respect to FIG. 4, each hash bucket 16 includes a queue of objects. In one embodiment, the queue is a singly-linked queue, which links the object stored in the hash bucket 16 to the object that is next lowest in popularity than the current object in the same bucket. A global descriptor (referred to herein as a global popularity descriptor) contains the key and popularity of the most popular object in the eviction bucket and the least popular object in each of the hash buckets, as described below with respect to FIG. 5. Popularity information is used to make eviction decisions and move content between the nodes 12 and eviction server 14, as described below.

It is to be understood that the network shown in FIG. 1 and described herein is only an example and that networks having different network devices, number of network devices, or topologies, may be used without departing from the scope of the embodiments. For example, as noted above, the distributed storage nodes 12 may include data structures other than a distributed hash table. Also, as previously described, the eviction server 14 may comprise any number of servers or a network comprising any number and arrangement of network devices.

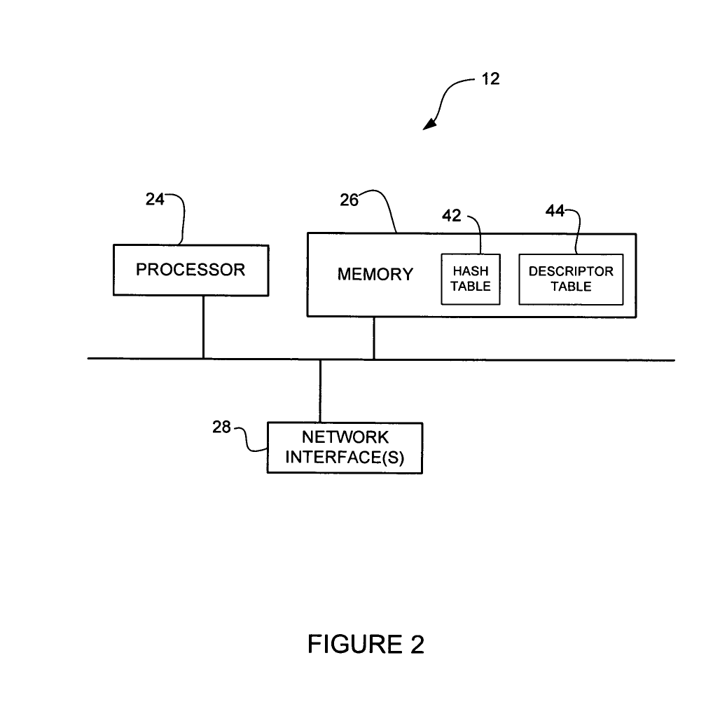

An example of a network device 12 that may be used to implement embodiments described herein is shown in FIG. 2. In one embodiment, the network device 12 is a programmable machine that may be implemented in hardware, software, or any combination thereof The device 12 includes one or more processors 24, memory 26, and one or more network interfaces 28. The memory 26 may include a hash table 42 and descriptor table 44 for use in content popularity tracking, as described in detail below.

Memory 26 may be a volatile memory or non-volatile storage, which stores various applications, modules, and data for execution and use by the processor 24. Logic may be encoded in one or more tangible media for execution by the processor 24. For example, the processor 24 may execute codes stored in a computer-readable medium such as memory 26. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interface 28 may comprise one or more wired or wireless interfaces (line cards, ports) for receiving signals or data or transmitting signals or data to other devices.

It is to be understood that the network device 12 shown in FIG. 2 and described above is only one example and that different configurations of network devices may be used.

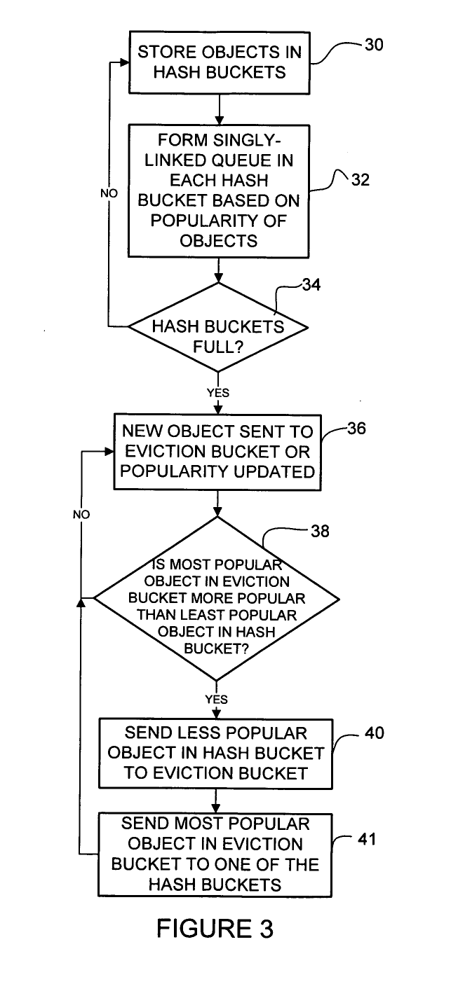

FIG. 3 is a flowchart illustrating a process for content popularity tracking and eviction in a distributed system, in accordance with one embodiment. When the system is first brought up, all newly created object descriptors are stored in the hash buckets 16 (step 30). A singly-linked queue is formed in each hash bucket 16 based on the popularity of the objects in each bucket (step 32). When the nodes 12 reach a certain threshold of disk usage, the system exits the startup phase and enters normal system operation. In normal operation all newly created object descriptors are stored first in the eviction bucket 18.

When a new object is sent to the eviction bucket 18 or the popularity of an object has been updated, the popularity of the most popular object in the eviction bucket is compared to the least popular objects in the hash buckets 16 (steps 36 and 38). The popularity of the most popular object in the eviction bucket 18 should not be more than the popularity of the least popular objects in the hash buckets 16. If the most popular object in the eviction bucket 18 is more popular than the least popular objects in the hash buckets 16, the objects are swapped. The less popular object in the hash bucket 16 is moved to the eviction bucket 18 (step 40) and the most popular object in the eviction bucket 16 is moved to one of the hash buckets 16 (step 41). The node 12 that receives the object from the eviction server 14 may be the same node that sent an object to the eviction server or may be a different node.

For example, if object A in hash bucket i is less popular than object B in the eviction bucket 18, these objects need to be swapped (i.e., object A moved to eviction bucket 18 and object B moved to one of the hash buckets 16). Object A is moved to the eviction bucket 18 and becomes the new most popular object. Object B is moved to one of the hash buckets 16. While object A will become the new most popular object in the eviction bucket 18, object B may not become the new least popular content in the hash bucket it moves to, even if it is the hash bucket i. The singly-linked queue of content popularity which exists inside the hash bucket 16 is used to find the proper place for object B in the queue, the new least popular content of the hash bucket to which object B was moved if it is different from i, and the new least popular object of the hash bucket i. The global popularity descriptor is also updated.

During normal operation, each hash bucket 16 maintains an approximately constant number of descriptors, as descriptors are only added to the hash buckets 16 via a swap with the eviction bucket 18. The eviction bucket 18, however, can continue to grow as new object descriptors are created. When the eviction bucket 18 reaches an eviction threshold, a block of descriptors and their related content are evicted from the system. It is not necessary that these evicted objects are the least popular in the system as they are all in the least popular eviction bucket.

FIG. 4 illustrates an example of the hash table 42 and descriptor table 44 located at the nodes 12, in accordance with one embodiment. The hash table 42 includes the key and value for each object, as previously described. Each value is associated with an object descriptor, which includes location of the object, popularity of the object, and a key to the next most popular object. This provides a singly-linked queue as described above. Since the objects are linked to the next most popular object, there is no need to order the objects based on popularity. This allows the objects to be sorted by their key.

The descriptor table 44 is preferably updated when any changes are made to the objects (e.g., new object received at the node, popularity of one or more objects updated).

FIG. 5 illustrates an example of the global popularity descriptor 46, in accordance with one embodiment. The global descriptor 46 includes the key and popularity of the most popular object in the eviction bucket 18 and the least popular object in each of the hash buckets 16. The global descriptor 46 may be stored at the eviction server 14, storage node 12, or one of the more of the eviction server, or storage nodes. The global descriptor 46 may be updated periodically (e.g., every five seconds or any suitable time period) or upon the occurrence of an event (e.g., receipt of new object, swap of objects, update of popularity). In one embodiment, an event notification mechanism is used to notify the nodes 12 of changes to the global popularity descriptor.

It is to be understood that the tables shown in FIGS. 4 and 5 are only examples and that any type of data structure or format may be used to store the information used to make eviction decisions.

Although the method and apparatus have been described in accordance with the embodiments shown, one of ordinary skill in the art will readily recognize that there could be variations made to the embodiments without departing from the scope of the embodiments. Accordingly, it is intended that all matter contained in the above description and shown in the accompanying drawings shall be interpreted as illustrative and not in a limiting sense.

What is claimed is:

1. A method comprising:
storing at a node in a distributed network of nodes, an object associated with an object descriptor comprising popularity information for said object, each of the nodes storing a plurality of said objects and said object descriptors, the node in communication with a server storing objects that are less popular than said objects stored at the nodes;
and transmitting from the node to the server, one of said objects identified as less popular than one of said objects at the server;
wherein one of the nodes receives and stores said one of the objects from the server.

2. The method of claim 1 wherein storing said object at the node comprises storing said object in a singly-linked queue, said objects linked together in the queue based on relative popularity.

3. The method of claim 1 wherein the nodes form an overlay distributed hash table network.

4. The method of claim 3 wherein each of said object descriptors further comprises a key to the next most popular object.

5. The method of claim 1 wherein said object is identified as less popular than one of said objects at the server based on a global descriptor comprising popularity of a most popular object at the server and popularity of a least popular object at each of the nodes.

6. The method of claim 1 further comprising receiving at the node, an object more popular than at least one of said objects stored at the nodes and storing said received object at the node.

7. The method of claim 6 wherein said new object is positioned in a queue based on popularity of said new object.

8. The method of claim 1 wherein the server comprises a plurality of storage devices.

9. The method of claim 1 further comprising updating said popularity information for one or more of said objects and comparing a most popular of said objects in the server with a least popular of said objects in each of the nodes.

10. An apparatus comprising memory for storing at a node configured for operation in a distributed network of nodes, objects associated with object descriptors each comprising popularity information for said object, each of the nodes comprising a plurality of said objects and said object descriptors, the node configured for communication with a server storing objects that are less popular than said objects stored at the nodes; and
a processor for transmitting from the apparatus to the server, one of said objects identified as less popular than one of said objects at the server;
wherein one of the nodes receives and stores said one of the objects from the server.

11. The apparatus of claim 10 wherein said objects are stored in a singly-linked queue, said objects linked together based on relative popularity.

12. The apparatus of claim 10 wherein the nodes form an overlay distributed hash table network.

13. The apparatus of claim 12 wherein each of said object descriptors further comprises a key to the next most popular object.

14. The apparatus of claim 10 wherein said object is identified as less popular than one of said objects at the server based on a global descriptor comprising popularity of a most popular object at the server and popularity of a least popular object at each of the nodes.

15. The apparatus of claim 10 wherein the processor is configured to place a new object received at the apparatus in a queue based on popularity of said new object.

16. Logic encoded in one or more tangible media for execution and when executed operable to:
store at a node in a distributed network of nodes, an object associated with an object descriptor comprising popularity information for said object, each of the nodes comprising a plurality of said objects and said object descriptors, the node in communication with a server storing objects that are less popular than said objects stored at the nodes; and
transmit from the node to the server, one of said objects identified as less popular than one of said objects at the server;
wherein one of the nodes receives and stores said one of the objects from the server.

17. The logic of claim 16 wherein said objects are stored in a singly-linked queue, said objects linked together based on relative popularity.

18. The logic of claim 16 wherein the nodes form an overlay distributed hash table network.

19. The logic of claim 18 wherein each of said object descriptors further comprises a key to the next most popular object.

20. The logic of claim 16 wherein said object is identified as less popular than one of said objects at the server based on a global descriptor comprising popularity of a most popular object at the server and popularity of a least popular object at each of the nodes.
